(19) United States
(12) Patent Application Publication
(10) Pub. No.: US 2023/0177477 A1
(43) Pub. Date: Jun. 8, 2023

(54) SMARTPAY ALLOCATION AS A SERVICE

(71) Applicant: ADP, Inc., Roseland, NJ (US)

(72) Inventor: Jyotsna Manikantan, Edison, NJ (US)

(21) Appl. No.: 17/541,908

(22) Filed: Dec. 3, 2021

(51) Int. Cl. G06Q 20/10; G06Q 40/00; G06Q 40/02

(52) U.S. Cl. CPC G06Q 20/102; G06Q 40/125; G06Q 40/02

(57) ABSTRACT

The present disclosure relates generally to a payment system and, more particularly, to a payment ecosystem in which bill payments are made through automatic deductions directly from an employee's net pay. The method includes: requesting, by a computer system, a net pay of a user provided in a payroll system; obtaining, by the computer system, financial obligations of the user associated with one or more financial accounts, the financial obligations including account information of the one or more financial accounts and an amount due associated with the account information; and paying, by the computer system, a predefined amount of the amount due of the financial obligations of the user from the net pay of the user.

### TECHNICAL FIELD

The present disclosure relates generally to a payment system and, more particularly, to a payment ecosystem in which bill payments are made through automatic deductions directly from an employee's net pay.

### BACKGROUND

It is not uncommon for people to have multiple financial accounts across many different institutions. These accounts may include savings account, checking accounts, money market accounts, etc. These same people may also use different credit cards, may have one or more outstanding loans, e.g., mortgages, automobile, student, etc., in addition to other outstanding financial obligations, e.g., utilities, etc. Almost all of the accounts have fees when a minimum balance is not maintained, or when minimum payments are not made.

The non-payment of a person's financial obligations, though, may have consequences. These consequences range from disruption of utilities, foreclosure, accumulated additional cost of service from increasing interest rates, overdraft charges, returned check proceedings, downgrade of creditworthiness, etc.

While many people have a combination of financial obligations and different accounts, they are often disjoined and disconnected from, for example, their income and other considerations. This requires an increased demand in time and attention of the user to monitor the many different accounts and make the necessary payments on time, manually and individually. As a result of these siloed systems that demand such attention, it is possible to miss payments, overdraft certain accounts, as well as be subject to other financial challenges and burdens. And such disruptions in payment can even have an impact on their employment.

### SUMMARY

In a first aspect of the present disclosure, a method includes: requesting, by a computer system, a net pay of a user provided in a payroll system; obtaining, by the computer system, financial obligations of the user associated with one or more financial accounts, the financial obligations including account information of the one or more financial accounts and an amount due associated with the account information; and paying, by the computer system, a predefined amount of the amount due of the financial obligations of the user from the net pay of the user.

In another aspect of the present disclosure, there is a computer program product. The computer program product includes one or more computer readable storage media having program instructions collectively stored on the one or more computer readable storage media. The program instructions are executable to: periodically in a pre-defined cadence automatically checking a net pay of a user by using a first API call to a payroll system; periodically in a pre-defined cadence automatically executing a search across financial accounts that match to a user's immutable identification by using a second API call to the financial accounts, the search determining a value of total amount due, a minimum amount due and a penalty amount when appropriate payments are not made; computing a total of minimum amount due associated with each verified financial account of the financial accounts, through a third API call; and when payroll is processed, automatically distributing payments from the net pay of the user across the verified accounts in an amount and priority order defined by the user.

In a further aspect of the present disclosure, there is system comprising a processor, a computer readable memory, one or more computer readable storage media, and program instructions collectively stored on the one or more computer readable storage media. The program instructions are executable to: obtain a net pay of a user from a payroll system; obtain financial obligations of the user which are recorded on one or more third party account systems; obtain a priority order and predefined amount to be paid from the user to the one or more third party account systems that have been verified by the user; pay the financial obligations of the user in the predefined amount and priority order; and notify the payroll system that certain financial obligations have been paid so that such payments are deducted from the net pay of the user prior to a payroll event; and notify the user of a status of a processing of the pay when complete, upon error, and/or to obtain confirmation when required.

### BRIEF DESCRIPTION OF THE DRAWINGS

Aspects of the present disclosure are described in the detailed description which follows, in reference to the noted plurality of drawings by way of non-limiting examples of exemplary embodiments of the present disclosure.

FIG. 1 is an illustrative architecture of a computing system implemented in embodiments of the present disclosure.

FIG. 2 shows an exemplary cloud computing environment in accordance with aspects of the present disclosure.

FIG. 3 shows a block diagram in accordance with aspects of the present disclosure.

FIG. 4 depicts an exemplary flow for enrollment and payment processes in accordance with aspects of the present disclosure.

FIG. 5 depicts an exemplary flow for transferring benefits to a new employer in accordance with aspects of the present disclosure.

FIG. 6 depicts an exemplary flow for implementing API calls in accordance with aspects of the present disclosure.

### DETAILED DESCRIPTION OF ASPECTS OF THE INVENTION

The present disclosure relates generally to a payment system and, more particularly, to a payment ecosystem in which bill payments are made through automatic deductions directly from an employee's net pay after mandatory deductions of applicable tax. In embodiments, the payment ecosystem comprises systems, methods and computer program products that may make automatic bill payments by use of deductions directly from a user's net pay, e.g., directly from a user's paycheck. More specifically, the payment ecosystem integrates a novel payment technology with a suite of payroll and/or human resource (HR) systems for an employer to assist in managing the financial life of their employees more efficiently, e.g., make bill payments of behalf of their employees, directly from an employee's payroll. Advantageously with the integration of the payment technology into a suite of payroll technologies, it is now possible to provide a holistic financial approach to support the employee's well-being through a connected experience.

In more specific embodiments, the payment system described herein can be a standalone service or integrated into payroll product offerings across the globe. For example, the payment system can be integrated into many different payroll products or human resource (HR) systems such as, e.g., ADP Workforce Now®, ADP RUN® and ADP Vantage®, amongst others. ADP Workforce Now® is a full-featured benefits administration system that allows an organization to gain increased control over benefits processes. ADP RUN® is a web-based payroll and human resources (HR) solution specifically designed for small businesses. ADP Vantage® is a strategically focused, globally scalable HR system that delivers unmatched expertise and service, comprehensive unified services to help unlock an organization's workforce's potential.

The payment system described herein may be referred to as Smart Pay Allocation as a Service (SPAAS), which is an intelligent pay allocation system, method, and computer program product to assist in autopayment of certain financial obligations of a user (employee) across many different accounts. These financial obligations and/or accounts may be, e.g., credit card accounts, mortgage payments, medical bills, auto loan payments, student loan payments, utility bills, etc. By using certain bill payment priorities pre-selected by a user, SPAAS may calculate the amount to be paid to a particular account though the use of payroll deductions to avoid overdue fees, etc., thereby protecting and ensuring financial wellness of an employee, i.e., providing holistic approach to an employee's financial fitness. In embodiments, SPAAS will obtain user consent for authorization of such payment in addition to audit tracking.

In even more specific embodiments, during an enrollment onboarding process, the employer may collect personal identifiable information such as employee name, date of birth, legal ID, e.g., SSN, FEIN, SIN, etc., address, and, importantly, bank account information for direct deposit of the employee's pay. The employer may also collect other information concerning bill payments such as, illustratively, payment information concerning, e.g., mortgage payments, auto loan payments, student loan payments, credit card information, etc. Prior to obtaining any information, SPAAS system will request authorization from the employee to opt into the service, e.g., SPAAS. For example, the employee can provide a check box, e.g., “I agree to Enable Smart Pay Allocation”, during an enrollment period. All of the information provided by the employee will be kept secure as described further herein.

The user consent provides authorization for SPAAS to check, through secure protocols, information such as minimum amounts due on each of the user's accounts and the penalty that may be incurred when not timely paid. The consent may also cover secure protocols that enable SPAAS to check the user's credit history to identify areas of opportunity through swift action remediation. The user can also authorize SPAAS to crawl across financial systems to detect additional accounts (e.g., financial obligations) associated with the user by matching identity information. SPAAS may also provide notification to the employee of any found accounts and information associated therewith, e.g., amount due, due date, minimum amount, penalties, etc. The user can review the list of accounts displayed and select the accounts to enable SPAAS for payment in a priority order, a minimum amount, etc. The user always has the ability to adjust payments or opt out of the system. Following user consent and entry of pertinent information, SPAAS may begin distributing portions of the employee payroll to particular financial accounts as authorized by the employee.

Accordingly, the systems, processes and computer program products described herein provide a technical solution to a problem by automatically addressing the financial health and well-being of an employee. SPAAS has broad applications and can work towards financial service simplification to improve financial well-being of the user. Generally, this technical solution can be accomplished through the use of, amongst other features as described herein, application program interface (API) calls which allow communication between different computing platforms such as, e.g., payroll systems, credit cards, bank accounts, mortgage holders, auto loan holders, student loan providers, etc. For example, the API may be configured to: (i) detect or ascertain an employee's net payroll (from a payroll system) after deduction of mandatory taxes, (ii) execute an amount due across all authorized financial accounts, in a priority order, and (iii) compute the total of minimum amount due in the order of the prioritized accounts that can be routed through SPAAS to each of the verified accounts, amongst other technical features described herein. Moreover, SPAAS is open ended, scalable, and extensible to enhance the holistic employee experience in financial wellness through technological transformations.

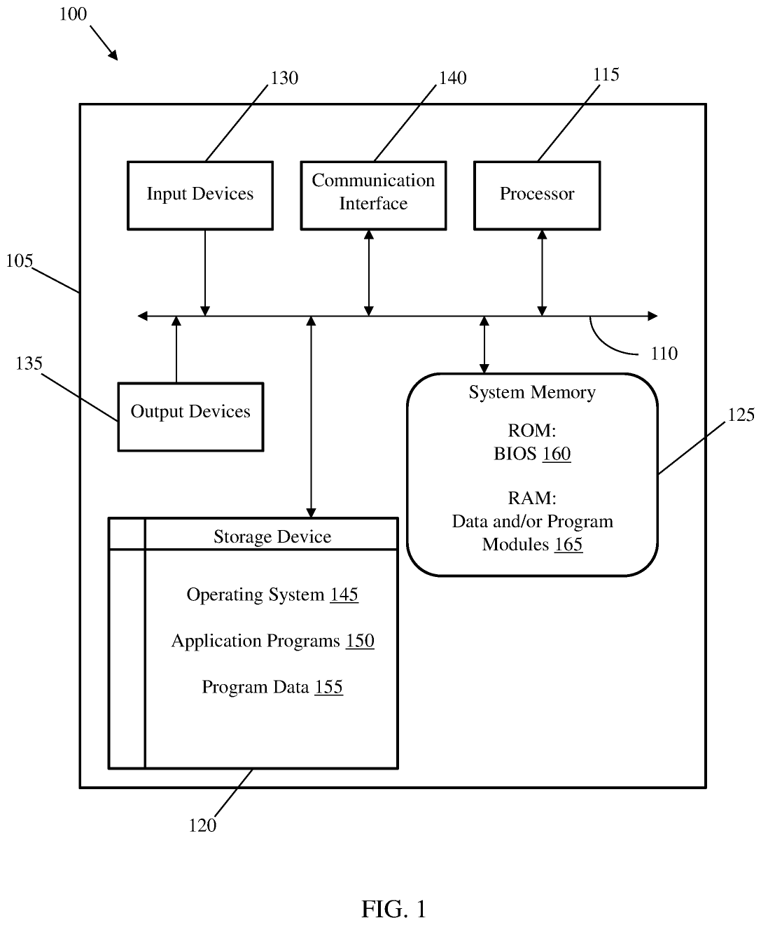

FIG. 1 is an illustrative architecture of a computing system 100 implemented in embodiments of the present disclosure. The computing system 100 is only one example of a suitable computing system and is not intended to suggest any limitation as to the scope of use or functionality of the disclosure. Also, computing system 100 should not be interpreted as having any dependency or requirement relating to any one or combination of components illustrated in computing system 100. In embodiments, computing system 100 may be representative of SPAAS.

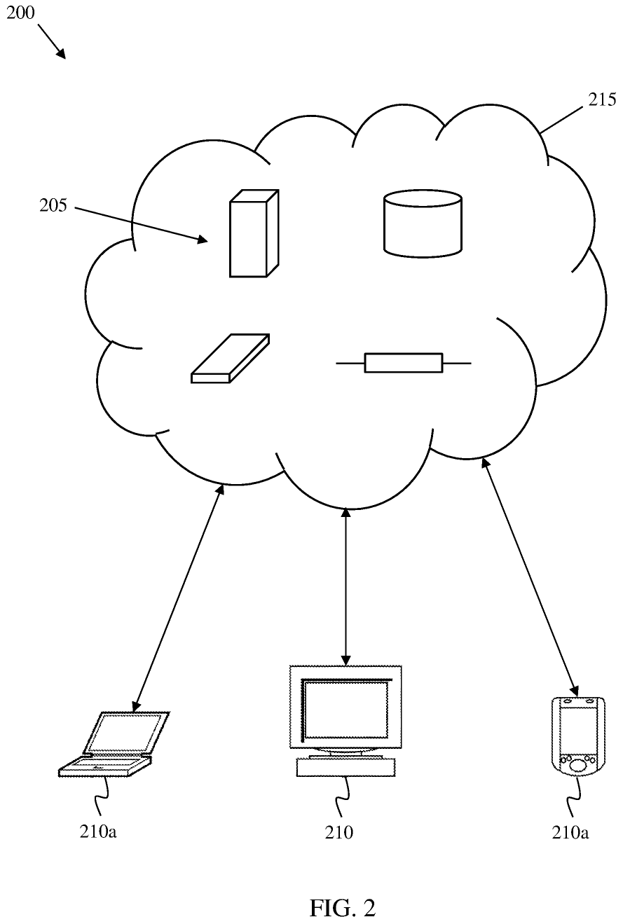

As shown in FIG. 1, computing system 100 includes a computing device 105. The computing device 105 can be resident on a network infrastructure such as within a cloud environment of FIG. 2, or may be a separate independent computing device (e.g., a computing device of a third party service provider or an employer). The computing device 105 may also be representative of SPAAS. The computing device 105 may include a bus 110, a processor 115, a storage device 120, a system memory (hardware device) 125, one or more input devices 130, one or more output devices 135, and a communication interface 140.

The bus 110 permits communication among the components of computing device 105. For example, bus 110 may be any of several types of bus structures including a memory bus or memory controller, a peripheral bus, and a local bus using any of a variety of bus architectures to provide one or more wired or wireless communication links or paths for transferring data and/or power to, from, or between various other components of computing device 105.

The processor 115 may be one or more processors or microprocessors that include any processing circuitry operative to interpret and execute computer readable program instructions, such as program instructions for controlling the operation and performance of one or more of the various other components or tasks of computing device 105. For example, processor 115 may make payments directly from an employee's net pay to different institutions, e.g., mortgage holder, credit card, student loan holder, or other institution, in a priority order as authorized by the user. By way of illustration, the employee may provide authorization to make payments to a particular institution in which the employee has certain financial obligations to, in a fixed amount paid, up to a maximum amount, a percentage amount, and the order of payments, which are then processed for an upcoming pay day, directly from a payroll system.

Accordingly, in embodiments, processor 115 interprets and executes the processes, steps, functions, and/or operations of the present disclosure, which may be operatively implemented by the computer readable program instructions. In embodiments, processor 115 may receive input signals from one or more input devices 130 and/or drive output signals through one or more output devices 135. The input devices 130 may be, for example, one or more mechanisms that permit an operator to input information to computing device 105 such as a keyboard, touch sensitive user interface (UI), etc. The one or more output devices 135 may include one or more mechanisms that output information to an operator, e.g., any display device, printer, etc.

The storage device 120 may include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 105 in accordance with the different aspects of the present disclosure. In embodiments, storage device 120 may store operating system 145, application programs 150, and program data 155 in accordance with aspects of the present disclosure. The storage device 120 may also store personal information of the employee as described herein such as, e.g., personal information, credit card information, mortgage information, or other bill or loan information, payment history, amounts to be paid to an institution, etc.

The system memory 125 may include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 160 (BIOS) including the basic routines that help to transfer information between the various other components of computing device 105, such as during start-up, may be stored in the ROM. Additionally, data and/or program modules 165, such as at least a portion of operating system 145, application programs 150, and/or program data 155, that are accessible to and/or presently being operated on by processor 115 may be contained in the RAM.

The communication interface 140 may include any transceiver-like mechanism (e.g., a network interface, a network adapter, a modem, or combinations thereof) that enables computing device 105 to communicate with remote devices or systems, such as a mobile device or other computing devices such as, for example, a server in a networked environment, e.g., cloud environment. For example, computing device 105 may be connected to remote devices or systems via one or more local area networks (LAN) and/or one or more wide area networks (WAN) using communication interface 140.

As discussed herein, computing system 100 and/or computing device 105 may be configured to provide payments to authorized institutions directly from a user's net pay. More specifically, computing system 100 and/or computing device 105 may detect or ascertain, from a payroll system, an employee's net payroll after deduction of mandatory taxes and other deductions, e.g., retirement savings, liens, etc., to arrive at a net pay. In embodiments, this can be performed resident on the computing system or through an API call to an integrated payroll system as described herein. In embodiments, a precheck of the payroll system may be performed automatically in the background at a predetermined time period, e.g., midnight on a daily basis, and values accumulated for weekly, biweekly etc., pay. This precheck may thus be used to determine the amount of net pay due to taxes, unpaid leave, etc. The values may be displayed dynamically on output device 135, e.g., graphical user display, to the user.

The computing system 100 and/or computing device 105 may also execute an amount due search across all financial accounts, as authorized for payment, with the dates when due. The search may be, for example, based on the information provided by the user or, if authorized, by crawling across financial systems to detect additional accounts associated with the user by matching identity information. This precheck may also be performed automatically in the background at a predetermined period of time, e.g., midnight, (self adjusting to the billing cycle which can vary) using an API call to different institutions (e.g., institutions such as mortgage provider, student loan provider, credit card, etc.). In this way, computing system 100 and/or computing device 105 may obtain information, for example, a value of total amount due and minimum amount due with and/without penalty amount for a variety of different institutions, e.g., credit card company, loan providers, or other debt holders. This information can be displayed dynamically on the output device 135.

Moreover, computing system 100 and/or computing device 105 may compute the total of minimum amount due in the order of the prioritized accounts, which is routed through computer system 100 (e.g., SPAAS) to each of the verified accounts. The computing system 100 and/or computing device 105 may also presents the total minimum amount as a deduction on the employee's payroll. Accordingly, when payroll is processed, for example, computing system 100 and/or computing device 105 may automatically redistribute the payment across the selected accounts for which it was computed, at which time SPAAS (computing system 100 and/or computing device 105) has completed the demand of the payments due and provides such payment information to the payroll system for appropriate deductions. The net balance may be sent to the user's preferred payment through the payroll system or computing system 100 and/or computing device 105.

In addition, computing system 100 and/or computing device 105 provides secure transactions. For example, at its core, computing system 100 and/or computing device 105, e.g., SPAAS, comprises a vault of sensitive personally identifiable information that remains protected within, for example, the storage device 120. In embodiments, only the owner of the information (e.g., employee) can view the entirely of their information. To maintain this security, for example, computing system 100 and/or computing device 105 may provide identity verification and authentication defined at the entry point to the system, e.g., home page (“My Pay Information page”). To make changes or updates, the user may provide passwords or biometric authentication options, e.g., face ID, touch ID, smart signatures, etc. The computing system 100 and/or computing device 105 may also use double factor authentication by sending the user a notification to verify their identity including, e.g., by taking their picture and capturing their face ID and/or fingerprint. This validation method may be used to display information and make changes to an account including addition of new providers.

In further embodiments, a cryptographic key may be generated from the identity values and used to encrypt all the SPAAS API calls associated with the employee. This encryption, by nature, is unique to each user and is used in the transit if API calls or other information, e.g., outreach crawling of the systems, to fetch data and to send payments to authorized systems. The computing system 100 and/or computing device 105 can deny all access to resources and data in the system unless the request is validated by, for example, a biometric signature or other identification mechanism. The biometric authentication or other identification mechanism may be verified at points in time to keep it current and accurate.

Moreover, using Secure Socket Language (SSL), each user-initiated action may require confirmation by entering a randomly generated token for access sent to a notification method on file that must be entered in the point of request to complete the transaction. The information, in its flow, may be scrambled and unintelligible to any intercepts to thereby protect the information and prevent fraudulent loss of sensitive information. Also, a timestamp in a request, response, or react process may be included which has very narrow margins for strong validation and time elapse rejects for protecting information. In addition, all transactions and updates between systems, e.g., payroll systems, SPAAS and payment systems, may be stored in a real-time database with logging for API calls, systems interacted, updates received, information transmitted, information processed, and updates to payroll. The payments to institutions may also follow secure wire transfer protocols that are used to send the online payments across the Internet.

In addition, computing system 100 and/or computing device 105 may use notifications to inform users of upcoming payments, completed payments, or errors in the processing of their payments to the prioritized list of providers for the amounts or percentages elected. The notification system may comprise secure emails to verified emails on file that may need to be unlocked with biometric information (touch ID, face ID, etc.) or keys, passwords, etc. Notifications may also include text message notifications to confirmed cellular telephone numbers on file, push notifications to smart mobile devices, etc. The notifications may include any links, requests or interactive elements that are part of a transaction processing, which may be verified with a random-access token or authenticator code for notification as an example. The notifications may also be (i) notices that a transaction has been completed with details of such activity for the user's record, (ii) errors that provide guidance for next steps and contact information to follow up, and/or (ii) proactive suggestive messages including, for example, expiring vacation days, tax savings options, new payments for consideration, etc.

Accordingly, computing system 100 and/or computing device 105 may perform tasks (e.g., process, steps, methods and/or functionality) in response to processor 115 executing program instructions contained in a computer readable medium, such as system memory 125. The program instructions may be read into system memory 125 from another computer readable medium, such as data storage device 120, or from another device via the communication interface 140 or server within or outside of a cloud environment. In embodiments, an operator may interact with computing device 105 via the one or more input devices 130 and/or the one or more output devices 135 to facilitate performance of the tasks and/or realize the end results of such tasks in accordance with aspects of the present disclosure. In additional or alternative embodiments, hardwired circuitry may be used in place of or in combination with the program instructions to implement the tasks, e.g., steps, methods and/or functionality, consistent with the different aspects of the present disclosure. Thus, the steps, methods and/or functionality disclosed herein can be implemented in any combination of hardware circuitry and software.

FIG. 2 shows an exemplary cloud computing environment 200 in accordance with aspects of the disclosure. Cloud computing is a computing model that enables convenient, on-demand network access to a shared pool of configurable computing resources, e.g., networks, servers, processing, storage, applications, and services, that can be provisioned and released rapidly, dynamically, and with minimal management efforts and/or interaction with the service provider. In embodiments, one or more aspects, functions and/or processes described herein may be performed and/or provided via cloud computing environment 200.

As depicted in FIG. 2, cloud computing environment 200 includes cloud resources 205 that are made available to client devices 210 via a network 215, such as the Internet. Cloud resources 205 can include a variety of hardware and/or software computing resources, such as servers, databases, storage, networks, applications, and platforms. In embodiments, the cloud resources may include, for example, payroll systems or human resource (HR) systems that are accessible by the client device 210 (e.g., computing system 100 and/or computing device 105).

Cloud resources 205 may be on a single network or a distributed network. Cloud resources 205 may be distributed across multiple cloud computing systems and/or individual network enabled computing devices. Client devices 210, 210a may comprise any suitable type of network-enabled computing device, such as servers, desktop computers, laptop computers, handheld computers (e.g., smartphones, tablet computers), set top boxes, and network-enabled hard drives. Cloud resources 205 are typically provided and maintained by a service provider so that a client does not need to maintain resources on a local client device 210, 210a.

Access to the cloud resources may be highly restricted and the sensitive personal information on user records remain encrypted. It is upon detection of the user's login and access to the SPAAS system that the information is decrypted to be readable by the individual. Also, as in any of the embodiments described herein, the user's access method including access to the computer, tablet, and mobile, as well as timestamps when the user views the SPAAS information and when making changes would be logged as part of securing the information and preventing fraudulent access. In the event the user is accessing such information from an unknown device or attempting to perform rapid changes that could be deemed abnormal, SPAAS would trigger a verification prompt to reconfirm the identity of the user.

In embodiments, cloud resources 205 may include one or more computing system 100 of FIG. 1 that is specifically adapted to perform one or more of the functions and/or processes described herein. Alternatively, client device 210, 210a may specifically be adapted to perform one or more of the functions and/or processes described herein, with client device 210a being, for example, a payroll and/or HR systems and an institution associated with payment of the employee's financial obligations, e.g., mortgage holder, etc. In embodiments, cloud resources 205 may also be payroll systems or HR systems integrated with SPAAS, e.g., one or more computing system 100 of FIG. 1. As should be understood, the payroll systems and/or human resource (HR) systems may, amongst other things, calculate net pay of an employee after deductions such as taxes, retirement savings, etc. This information may then be accessed by the computing system (e.g., SPAAS) to make payments to the institution as representative by computing systems 210a.

The cloud resources may include databases that store user information, e.g., personal identifiable information such as employee name, date of birth, legal ID, e.g., SSN, FEIN, SIN, address, bank account information, credit card information, and/or payment information, e.g., mortgage holder and account information, auto loan holder and account information, etc. As noted herein, the personal identifiable information is securely stored in a database.

Cloud computing environment 200 may be configured such that cloud resources 205 provide computing resources to client devices 210, 210a through a variety of service models, such as Software as a Service (SaaS), Platforms as a service (PaaS), Infrastructure as a Service (IaaS), and/or any other cloud service models. Cloud resources 205 may be configured, in some cases, to provide multiple service models to a client device 210. For example, cloud resources 205 can provide both SaaS and IaaS to a client device 210. Cloud resources 205 may be configured, in some cases, to provide different service models to different client devices 210, 210a. For example, cloud resources 205 can provide SaaS to a first client device 210, 210a and PaaS to a second client device 210, 210a.

Cloud computing environment 200 may be configured such that cloud resources 205 provide computing resources to client devices 210, 210a through a variety of deployment models, such as public, private, community, hybrid, and/or any other cloud deployment model. Cloud resources 205 may be configured, in some cases, to support multiple deployment models. For example, cloud resources 205 can provide one set of computing resources through a public deployment model and another set of computing resources through a private deployment model.

In embodiments, software and/or hardware that performs one or more of the aspects, functions and/or processes described herein may be accessed and/or utilized by a client (e.g., an enterprise or an end user) as one or more of SaaS, PaaS, and IaaS model in one or more of a private, community, public, and hybrid cloud. Moreover, although this disclosure includes a description of cloud computing, the systems and methods described herein are not limited to cloud computing and instead can be implemented on any suitable computing environment.

Cloud resources 205 may be configured to provide a variety of functionality that involves user interaction. Accordingly, a user interface (UI) can be provided for communicating with cloud resources 205 and/or performing tasks associated with cloud resources 205. The UI can be accessed via a client device 210 in communication with cloud resources 205. The UI can be configured to operate in a variety of client modes, including a fat client mode, a thin client mode, or a hybrid client mode, depending on the storage and processing capabilities of cloud resources 205 and/or client device 210. Therefore, a UI can be implemented as a standalone application operating at the client device in some embodiments. In other embodiments, a web browser-based portal can be used to provide the UI. Any other configuration to access cloud resources 205 can also be used in various implementations.

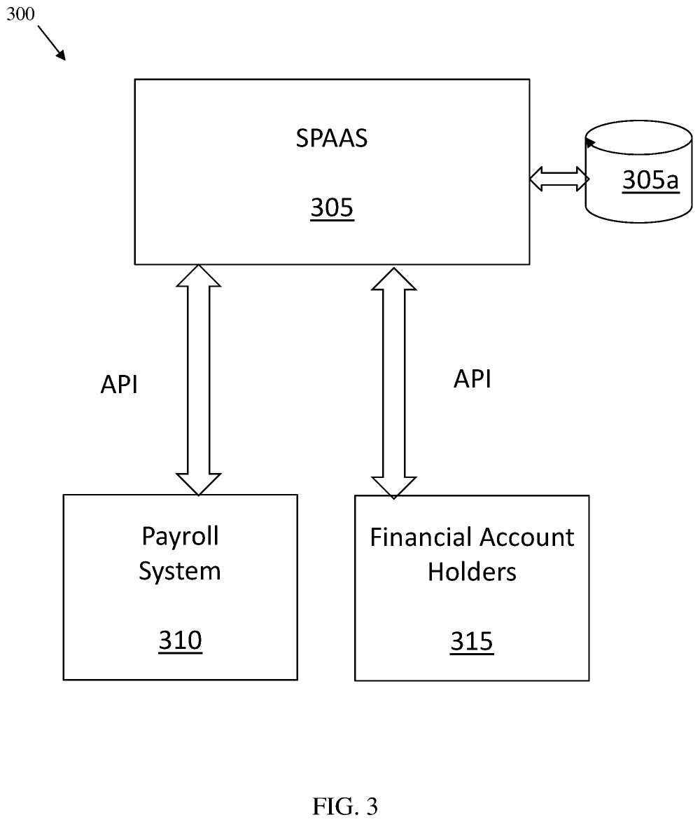

FIG. 3 shows a block diagram in accordance with aspects of the present disclosure. More specifically, FIG. 3 shows a functional block diagram 300 that illustrates functionality of aspects of the present disclosure. The block diagram includes SPAAS 305, a payroll system 310 and a financial account system 315. As already noted, SPAAS 305 may comprise computing system 100 and/or computing device 105 of FIG. 1 or client device 210 of FIG. 2.

In embodiments, SPAAS 305 comprises a computer system configured to provide the following functionality, in the least: (i) an API call to detect a person's net payroll after deduction of mandatory taxes, liens, etc. from payroll system 310; (ii) an API call to execute an amount due across financial accounts 315; and (iii) and API call to compute the total of minimum amount due in the order of the prioritized accounts that can be routed through SPAAS 305 to each of the verified accounts 315. In embodiments, the first and second API calls can be automatic prechecks, with the third API presenting the amount due as a payroll deduction on the employee's payroll from a payroll system 310.

In addition, SPAAS 305 may integrate with the payroll system 310 to ensure proper payment of amounts due, updates to the net pay of the employee though automatic payments, as well as providing secure storage and access to the employee information within database 305a. In embodiments, for example, the secure database 305a may include any and all financial and/or personal information as described herein including, e.g., (i) date of birth; (ii) legal ID; (iii) name; (iv) address; (v) biometrics; (vi) employment history; (vii) banking information; (viii) payment information and history (e.g., transactions); (ix) priority order of payment; (x) events; and (xi) audit logging, etc. In addition, SPAAS 305 may provide additional functionality though an API call including, e.g.: (i) user payee identification, (ii) priority of payments, (iii) amount or percentage to be paid; (iv) payments due; (v) minimum amount due and dates when due for payee in the selected priority. As already described, all of the transactions, notifications, etc. will remain secure in the database 305a, during transit and for any notifications.

In further embodiments, SPAAS 305 may detect a number of days of vacation time remaining that may expire at the end of the calendar year and, using this information, SPAAS 305 may send a message to the employee informing them to use the days for vacation. SPAAS 305 may also provide budget information, as it knows the net pay and expenses of the employee. In this way, SPAAS 305 may provide recommendations based on a cost analysis and, by crawling to find travel accounts based on their identity information, to provide suggestions for travel that are closely aligned to the vacation budget guidelines for the number of days of vacation, with options to continue or cancel. SPAAS 305 may also provide log in to a travel site and complete the purchase with a preferred payment method.

In further embodiments, SPAAS 305 may be a proactive system integrated with payroll system, 310. For example, SPAAS 305 may provide the first API call to the payroll system 310 to review pay projections, time logged, user leave status and status of pay, e.g., the employee will not be paid this upcoming pay period. In the situation that the employee is not being paid, e.g., NET ZERO pay, a business exception will be used that gathers payments due information, and initiates through an alert notification to the user (email, push, text, etc.) though the third API call. In this way, SPAAS 305 informs the user that for the pay period there is NET ZERO PAY, provides the user the amounts due for the prioritized list on their account and provides a call-to-action message to arrange for alternate pay arrangement prior to upcoming due dates.

In addition, by having payroll system 310 integrated with SPAAS 305, SPAAS 305 may be aware of the taxation that pertains to each employee based on their own personal situation, e.g., work information, demographics, state, etc. By utilizing this information, SPAAS 305 can monitor pay statements and tax issues, e.g., W2 forms. Accordingly, when SPAAS 310 detects the employee has options to reduce taxes by investing retirement accounts, e.g., IRA, 401k, 529 plans, or through taxable donations, etc., SPAAS 305 may prompt the user to consider such elections and provide links to sites for simplifying the employee experience.

In embodiments, payroll system 310 comprises a computer system configured to provide the above functionality, in addition to: (i) payroll computations based on days worked, payrate, time off, tax deductions pay per day period, frequency of pays, next payroll process date, and holidays. Payroll system 310 may provide this information through an API call to SPAAS 305. In further embodiments, payroll system 310 may deduct from the net pay (as instructed by SPAAS 305) made to an account holder and direct deposit to the employee's bank account and remaining amounts.

The payroll system 300 may also be integrated with SPAAS 305 to provide an integrated, holistic approach to an employee's well-being. That is, SPAAS 305 may be in communication with payroll system 310 to provide prechecks and any additional information as provided herein. The payroll system 310 may also provide additional information such as, e.g., (i) bonus, (ii) leave, (iii) live in and work in state, (iv) tax rates, (v) pay cycles, (vi) deductions, (vii) pay dates, (viii) payment method, (ix) employment loans, etc., any of which may be used by SPAAS 305. As already described, all of the transactions, notifications and other information will remain secure.

In embodiments, financial account system 315 comprises a computer system configured to provide the following functionality through an API call from SPAAS 305: (i) payment disbursements to an account holder; (ii) balances deposited to an account or receipt of a check; (iii) failed payment information; (iv) payment due (including minimum amount); (v) due dates of payments; (vi) penalties for late or missed payments; (vii) frequency of payments, (viii) payment history, etc. The financial account system 315 may also be integrated with SPAAS 305 to provide an integrated, holistic approach to an employee's wellbeing, e.g., provide financial obligations of the employee as described herein including user notifications and acknowledgements, which can be passed through SPAAS 305 to the user, or provided directly to the user. As already described, all of the transactions, notifications and other information will remain secure.

Also, each of these functionalities provided by SPAAS 305, payroll system 310 and financial account system 315 may comprise one or more program modules providing each of the above functionality. The program modules 165 may be separate modules or may be integrated into a single module. Additionally, or alternatively, a single module may be implemented as multiple modules. Moreover, the quantity of devices and/or networks in the environment is not limited to what is shown in FIG. 3. In practice, the environment may include additional devices and/or networks; fewer devices and/or networks; different devices and/or networks; or differently arranged devices and/or networks than illustrated in FIG. 3.

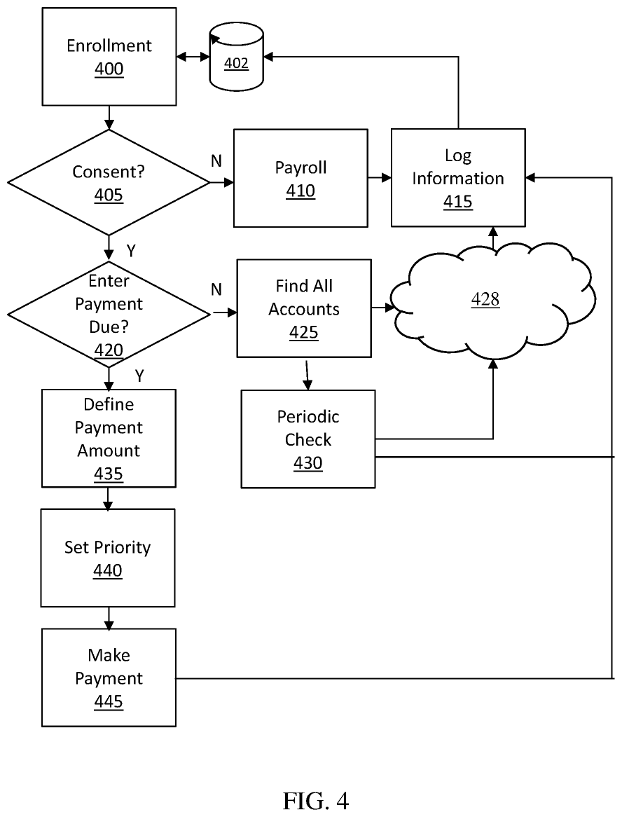

FIGS. 4-6 depict exemplary flows for processes in accordance with aspects of the present disclosure. The exemplary flows can be illustrative of a system, a method, and/or a computer program product and related functionality implemented on the computing system of FIG. 1. The computer program product may include computer readable program instructions stored on computer readable storage medium (or media). The computer readable storage medium may include the one or more storage medium as described with regard to FIG. 1, e.g., non-transitory media, a tangible device, etc. The method, and/or computer program product implementing the flows of FIGS. 4-6 can be downloaded to respective computing/processing devices, e.g., computing system of FIG. 1 as already described herein, or implemented on a cloud infrastructure as described with regard to FIG. 2. Accordingly, the processes associated with each flow of the present disclosure can be implemented by special purpose hardware-based systems that perform the specified functions or acts or carry out combinations of special purpose hardware and computer instructions.

More specifically, FIG. 4 shows an enrollment and payment process of SPAAS in accordance with aspects of the present disclosure. At step 400, an employee begins the enrollment process by providing certain personal information. In embodiments, the user personal information may include first name, last name, date of birth, address, and legal identification, including, for example, driver's license information, etc. The processes may also provide the employee with the option to add their email address, cellular telephone numbers, and their smart devices to use for additional authentication, etc. The personal information can also be used for future login and validation purposes, including for example, biometric authentication which can be logged at step 415, with successful validation required to make changes to SPAAS. This personal information may be saved in the secure database 402.

Still referring to step 400, additional information may be provided by the employee and/or employer, which may be periodically updated, during the enrollment process. The additional information may be, for example, user position and pay, and user payroll output information. The user position and pay information may include, for example, pay information, payroll frequency, mandatory tax deductions, work hours, time off, absences, etc. The user payroll output may include payroll paid by direct deposit or check, verified routing information and secure payment gateway information. In embodiments, this information may also be stored in a secure database as 402, with any required associations.

At step 405, a determination is made as to whether SPAAS is enabled, and the employee has provided consent for payment to any number of account holders. This consent may also be used for future adjustments of payment or account holders, as examples. If no consent has been provided, the process will continue to payroll processing at step 410. The payroll processing will be logged at step 415 and stored in the database 402.

If consent is provided, at step 420, a determination is made as to whether a payment due information has been entered by the employer. If not, at step 425, the process will find all accounts. This may be done by crawling through financial institutions for matching identification information with the employee and, if found, determining any amounts due, penalties, minimum amount payable, due date, etc. as shown at reference numeral 428. More specifically, in embodiments, the processes will find digital accounts with payments such as, for example, credit cards, mortgages, loans, utility bills, etc. The processes will also find payment due including total payments, minimum payments, payment due dates and processing times. The employee will provide consent and authorization for any payments that may be required for these digital accounts. This information is then logged at 415 and saved in the database 402.

In addition, period checks for any updated information may be provided at step 430, which again can be logged at step 415 and stored in the database 402. The periodic updates can be set for any predetermined time period, preferably prior to the issuance of a paycheck. In embodiments, the periodic checks can also determine that an employee has paid off a certain financial obligation with the recent pay period. This information, as with all of the information, may then be provided to the employee via a notification, e.g., SPAAS confirms a ZERO DUE status and notifies the employee that an amount that was previously allocated to be paid is no longer required and would be deposited or paid back to the employee's preferred payment method. These periodic checks may be provided by API calls from SPAAS already described herein.

In addition, as the processes are an intelligent system which can detect opportunities that could be paid during the periodic check, at step 430 or during the processes of step 425. Accordingly, the processes can find new financial obligations, e.g., bills that have since surfaced, have high out standings, higher penalties, etc., and provide this information to the employee in a holistic approach. These additional information/assessments may then be provided to the employee though notifications from SPAAS in order to make any needed adjustments to the payments and deductions from payroll. As with any adjustments, these should be authorized by the employee. Accordingly, this provides the employee with an opportunity to review new opportunities and add them to their list as additional “pay to” or update their current selections and priority to accommodate certain suggestions provided by SPAAS.

At step 435, the employee may define the payment amount. The payment amount may be a fixed dollar amount of a percentage amount, as examples. As step 440, the employee may also set a priority order for payment of their financial obligations. The payment amount in the priority order will be deducted from the employee's net pay. The priority order and payment amount will be logged and sored in the database. At step 445, the processes will make the appropriate payments directly from an employee's net pay, which will again be logged at step 415 and saved in the database 402. In embodiments, after the first pay cycle, the processes may keep checking for changes in the employee's pay and the “payments due”, “pay to”, and to identify “new entities” that are associated with the employee with financial dues, e.g., new bills or loans, etc., in order to make the appropriate adjustments for payment from a net pay calculation.

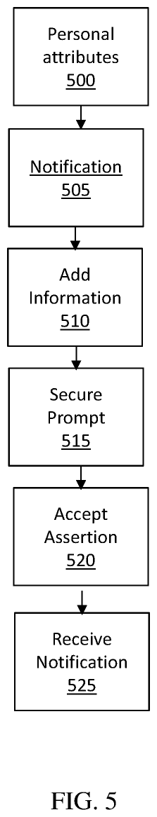

FIG. 5 shows processes of transferability of the benefits of SPAAS to a new employer. Prior to discussing the processes shown FIG. 5, it should be understood that the personal information as described with respect to FIG. 4 is a unique immutable personal ID associated with a particular person. In this way, the functionality and benefits of SPAAS may be transferrable between employers when initiated by the employee.

For example, when starting a new job, at step 500, personal ID attributes can be provided to SPAAS which, in turn, at step 505, SPAAS may send a notification to the person requesting confirmation of a change in their employer. At step 510, the processes will add the “new employer” and “new employee” relationship and, if there is integration between SPAAS and the company payroll system, relate to the payroll data systems linked with their legal ID of the new employee. Upon confirmation, at step 515, the processes provide a biometric authentication or other secure prompt for the new employee to accept and acknowledge the new employment. At step 520, the processes accept the assertion and provide the employee the opportunity to link their previous account with the new employer. At step 525, the new employer may also receive a notification of this request to provide SPAAS financial fitness to their new employee. On successful linking, the employee will continue to benefit from SPAAS intelligence which proactively supports their financial fitness. The transferability option becomes available to employers who have subscribed to the SPAAS platform for their workforce.

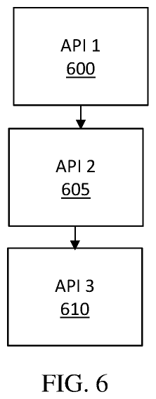

FIG. 6 depicts an exemplary flow for implementing API calls in accordance with aspects of the present disclosure. At step 600, the processes detect the person's net payroll after deduction of mandatory taxes or other deductions to arrive at a net pay. This is performed through a first API call to the payroll system. Like all APIs, this API call may be fully hashed and encrypted for secure transmission. This precheck may be performed automatically in the background at a predetermined time, e.g., midnight on a daily basis. The values obtained from the payroll system may be accumulated for weekly, biweekly etc. pays. The values may be displayed dynamically to the employee.

At step 605, the processes execute an amount due search across all financial accounts using a second API call. In embodiments, the information for the financial accounts may be provided the employee. In addition to or alternatively, upon authorization from the employee, the processes may crawl through financial accounts to determined additional employee obligations that were not provided by the employee. These processes may determine pay allocation, dates when due, minimum amounts due, penalties, etc. In embodiments, this may be a precheck performed done automatically in the background at a predetermined time, e.g., midnight, with a provision for self-adjusting to the billing cycle. The value of total due and minimum amount due and penalty amount may be displayed dynamically to the employee.

At step 610, through a third API call, the processes may compute the total of minimum amount due in the order of the prioritized accounts that can be routed through SPAAS to each of the verified accounts. Next, the processes may present the total minimum amount as a deduction on the employee's payroll. When payroll is processed, the processes may then automatically redistribute the payment across the selected accounts for which it was computed. The SPAAS system has now completed the demand of the payments due, and the net balance is sent to the user's preferred payment. The third API may also be used to provide notifications of amounts due, adjustments, fully paid accounts, to make suggestions, etc.

In an exemplary use case, the employee enrolls in SPAAS. This enrollment may include providing personal information and account information which should be paid directly from a net pay of the employee. The employee may set forth a percentage of the amount due and a priority of payments, e.g., in priority order, 10% for a credit card that at least meets the minimum amount due, full payment of utility bill and $250 for auto loan. The employee may provide the due date for payment, or this may be automatically found by SPAAS. During a pay period, SPAAS may periodically check a payroll system to determine if sufficient funds are available for payment to the accounts on or before their due date. If so, SPAAS may make the payment in the priority order and amount authorized, with a notification to the user that such payment has been made. If there are not enough funds available in the employee's net pay for each of the authorized payments, SPAAS may provide notification to the employee with a suggestion for alternative payment schedules, amounts, etc. SPAAS may also communicate with the payroll system to ensure that the amount paid is deducted from the net pay of the employee.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

1. A method, comprising:
configuring application program interface (API) calls to a payroll system and to one or more financial accounts to ascertain a user's net pay from the payroll system and execute an amount due across the one or more financial accounts, in a priority order;
generating a cryptographic key from identity values of the user and which are used to encrypt the API calls associated with the user;
requesting, by a computer system, the net pay of a user provided in the payroll system using the API calls;
obtaining, by the computer system, financial obligations of the user associated with the one or more financial accounts using the API calls, the financial obligations including account information of the one or more financial accounts and an amount due associated with the account information; and
paying, by the computer system, a predefined amount of the amount due of the financial obligations of the user from the net pay of the user.

2. The method of claim 1, wherein the paying is in a priority order as defined by the user and further comprising using Secure Socket Language (SSL), each user-initiated action requiring confirmation by entering a randomly generated token for access sent to a notification method that is entered to complete the payroll processing.

3. The method of claim 1, further comprising prechecking, by the computer system, the financial obligations of the user and the net pay, prior to the paying, wherein the prechecking is performed on a predetermined time period prior to a payment due date of the financial obligations.

4. The method of claim 3, wherein the prechecking is performed by the application program interface (API) calls to the payroll system and to the one or more account holders, which allow electronic communication between different computing platforms including the payroll system, the one or more financial accounts and an integrated system which coordinates payment from the net pay to the one or more account holders.

5. The method of claim 3, wherein the API calls are configured to: (i) detect or ascertain the net pay of the user after deductions, (ii) execute an amount due across all authorized financial accounts, in a priority order, and (iii) compute a total of minimum amount due in a predefined priority order that can be routed through the integrated system to each of the authorized financial accounts that have been verified.

6. The method of claim 1, wherein the API calls are encrypted and further comprising generating timestamps when the user makes changes that are logged as part of securing information and preventing fraudulent access to the payroll system and triggering a verification prompt to reconfirm an identity of the user.

7. The method of claim 3, wherein the obtaining comprises crawling through financial systems to find a match between the user and financial accounts, and further comprising providing notification to the user that financial obligations have been found that require payment.

8. The method of claim 3, further comprising obtaining, by the computer system, personal information of the user including legal ID and bank account information which is matched to information of the one or more financial accounts for verification.

9. The method of claim 8, wherein the requesting, obtaining, paying and prechecking are provided through secure protocols from disparate systems.

10. The method of claim 9, wherein the obtaining includes minimum amounts due on each account of the user and a penalty that may be incurred when not timely paid and a minimum amount due.

11. The method of claim 1, further comprising providing notifications to the user that payments have been made to the one or more financial accounts and that a deduction has been made from the net pay of the user.

12. The method of claim 1, further comprising calculating, by the computer system, a budget of the user using the net pay, the financial obligations and the payment of the predefined amount to the one or more financial accounts.

13. The method of claim 1, further comprising proactively reviewing, by the computing system, pay projections, time logged, user leave status and status of pay of the user for an upcoming pay period and, using this information, inform the user which financial obligations cannot be met and request alternative methods of payment be found.

14. A computer program product stored on one or more computer readable non-transitory storage media having program instructions collectively stored on the one or more computer readable non-transitory storage media, wherein the computer program product is executed on a computing system to:
periodically in a pre-defined cadence automatically checking a net pay of a user by using a first API call to a payroll system;
periodically in a pre-defined cadence automatically executing a search across financial accounts that match to a user's immutable identification by using a second API call to the financial accounts, the search determining a value of total amount due, a minimum amount due and a penalty amount when appropriate payments are not made;
computing a total of minimum amount due associated with each verified financial account of the financial accounts, through a third API call;
when payroll is processed, automatically distributing payments from the net pay of the user across the verified accounts in an amount and priority order defined by the user; and
storing all transactions in a real-time database with logging for the first, second and third API calls, systems interacted, updates received, information transmitted, information processed, and updates to the payroll.

15. The computer program product of claim 14, wherein the periodically executing the search and checking the net pay are automatically performed prior to a payroll event of the user and further comprising, using Secure Socket Language (SSL), each user-initiated action requiring confirmation by entering a randomly generated token for access sent to a notification method that is entered to complete the payroll processing.

16. The computer program product of claim 15, wherein the first API call is configured to ascertain the net pay of the user after deductions, the second API call is configured to execute an amount due search across all authorized financial accounts, and the third API call is configured to execute payment due in a predefined priority order that can be routed through the payroll system to each authorized and verified financial account.

17. The computer program product of claim 16, wherein the first, second and third API calls are encrypted and further comprising generating timestamps in when the user makes changes that are logged as part of securing information and preventing fraudulent access to the payroll system and triggering a verification prompt to reconfirm an identity of the user.

18. The computer program product of claim 17, further comprising crawling through financial systems to find a match between the user and financial accounts, and further comprising providing notification to the user that financial obligations have been found that require payment.

19. The computer program product of claim 14, further comprising providing secure notifications to the user that payments have been made to the verified financial accounts and that a deduction has been made from the net pay of the user.

20. A system comprising:
a processor, a computer readable memory, one or more computer readable storage media, and program instructions collectively stored on the one or more computer readable storage media, the program instructions executable which are executable by the processer to perform the following steps:
configure application program interface (API) calls to a payroll system and to one or more financial accounts to ascertain a user's net pay from the payroll system and execute an amount due across the one or more financial accounts, in a priority order;
generate a cryptographic key from identity values of the user and which are used to encrypt the API calls associated with the user;
obtain the net pay of a user from the payroll system using the API call to the payroll system;
obtain financial obligations of the user which are recorded on one or more third party account systems comprising the one or more financial accounts and using the API calls to the one or more financial accounts;
obtain a priority order and predefined amount to be paid from the user to the one or more third party account systems that have been verified by the user;
pay the financial obligations of the user in the predefined amount and priority order; and
notify the payroll system using the API calls to the payroll system that certain financial obligations have been paid so that such payments are deducted from the net pay of the user prior to a payroll event; and
notify the user of a status of a processing of the pay when complete, upon error, and/or to obtain confirmation when required.
